(19) United States
(12) Patent Application Publication
(10) Pub. No.: US 2007/0163851 A1
(43) Pub. Date: Jul. 19, 2007

(54) HIGH THERMAL TRANSFER CALIPER

(76) Inventor: Derek Alexander, Mequon, WI (US)

Correspondence Address: WHYTE HIRSCHBOECK DUDEK S.C., ONE EAST MAIN STREET, SUITE 300, MADISON, WI, 53703-3300, US

(21) Appl. No.: 11/617,954

(22) Filed: Dec. 29, 2006

Related U.S. Application Data
(60) Provisional application No. 60/754,781, filed on Dec. 29, 2005.

(51) Int. Cl. F16D 65/853

(52) U.S. Cl. 188/264 F

(57) ABSTRACT

A brake caliper includes a housing having at least one bore formed therein. A coolant passage is formed through the housing and extends radially outwardly from the bore and is fluidically coupled thereto. The coolant passage can accept a coolant, which can be actively moved or it can be passively moved. The brake caliper also has at least one piston slidably mounted in the bore. The piston can be made from a thermally conductive material. The piston can include a wall that is thicker at a first end there of than at the second end thereof. The thicker end is that which contacts a brake pad. A method of cooling a disc brake assembly is also provided. The coolant passage takes heat out of the disc brake assembly before it reaches the brake fluid. Heat is dissipated by thermal exchange into the caliper, coolant, and/or the atmosphere.

### CROSS-REFERENCES TO RELATED APPLICATIONS

This application claims priority under 35 U.S.C. §119(e) to U.S. Provisional Patent Application No. 60/754,781, filed Dec. 29, 2005, the entirety of which is incorporated by reference herein.

### FIELD OF THE INVENTION

In general, the inventive arrangements relate to brakes and braking systems, and more specifically, to cooled brake calipers.

### DESCRIPTION OF THE RELATED ART

Caliper disc brakes generally include a caliper housing having a brake pad assembly supported in the housing on each side of a disc brake rotor. Typically, both brake pad assemblies are mounted on movable pistons that can be mechanically or hydraulically driven into engagement with the rotor. Alternatively, one of the brake pad assemblies could be driven into engagement with the rotor, and the other brake pad could be pulled into engagement with the rotor due to the caliper housing movement or due to deflection of the brake disc.

Brake calipers must be capable of withstanding the heat created by the friction of brake pads rubbing against the brake disk. When used in high speed, high torque, and/or high duty cycle applications such as motorcycles, brake calipers tend to overheat because of the large quantities of energy that must be absorbed by the brakes during braking, often causing the brake fluid to boil. Regular brake fluid boils at about 350° F. and high-temperature brake fluid boils at from 400 to 500° F. However, brake fluid absorbs water, which lowers its boiling point. Over time, the boiling point of brake fluid containing water may drop to virtually the boiling point of water, e.g., to around 230° F. to 250° F. In situations where brake fluid boils, brake life is adversely affected.

Attempts have been made to address the overheating of brake fluid. In one early design, an extruded aluminum manifold was inserted between the pad and the piston of a brake caliper. Water was pumped through the manifold to directly cool the pad and piston. This system was manufactured only with considerable difficulty and expense because extruded aluminum had to be extrusion-bent, had welded end caps, yet still had to be watertight. It was also relatively heavy.

In another, later system, the good thermal conductivity of an aluminum brake caliper housing was taken advantage of to cool the piston indirectly via conductive heat transfer with a coolant, thereby negating the need to produce a complex manifold to supply coolant directly to the piston. In this system, an aluminum, water cooled housing was mounted on the top of the main caliper housing. Several longitudinal cavities were formed in the top of the main caliper housing in fluid communication with first and second lateral cavities in the water cooled housing. Coolant inlets and outlets in the caliper housing opened axially into the first and second axially-offset lateral passages in the water cooled housing. The lateral passages in the water cooled housing were separated by baffles to promote water circulation through the longitudinal cavities in the main caliper housing. With this arrangement, water entering the inlet port of the water cooled housing flowed into the first lateral passage and was deflected through all three longitudinal cavities in the main caliper housing by baffles that separated the cavities from one another. The water then flowed into the second lateral passage in the water cooled housing and was directed back to the engine coolant system via the outlet opening.

An additional previous system, used a bore formed in a brake caliper and a coolant passage formed in the bore to cool the brake caliper. The coolant passage was a single-pass passage having a coolant inlet and a coolant outlet. The coolant passage was fluidically isolated from the bore. This caliper used conductive heat transfer from the hot brake fluid in the caliper to the coolant passage.

The arrangements described above effectively cool the caliper housing but have several disadvantages. The baffled main caliper housing, though easier to manufacture than the earlier system described above, is still relatively complex and expensive to manufacture. It is also relatively heavy, undesirably contributing to a reduced acceleration-to-weight ratio in the vehicle using the brake caliper. In addition, the convoluted path of the fluid flow through the water cooled housing results in turbulent flow and considerably restricts fluid flow through the housing. More engine horsepower therefore is required to run the water pump at an effective rate than if the liquid flow were laminar and unrestricted.

The caliper having a single-pass coolant passage avoids problems associated with the manifold caliper and the aluminum caliper with baffles. However, the caliper having a single-pass coolant passage has its disadvantages also, including cooling brake fluid, but only after the fluid heats up.

Therefore, it would be desirable to provide a cooled brake caliper that is less expensive and easier to manufacture than at least some of the earlier known cooled brake calipers. It would also be desirable to reduce the cost of manufacturing a cooled brake caliper. It would also be desirable to reduce the weight of a cooled brake caliper. Additionally, it would be helpful to remove heat from a brake caliper before the heat reaches the brake fluid.

### SUMMARY OF THE INVENTION

The invention, which is defined by the claims set out at the end of this disclosure, is intended to solve at least some of the problems noted above. A brake caliper is provided and includes a housing having at least one bore formed therein. A coolant passage is formed through the housing and extends radially outwardly from the bore and is fluidically coupled to the bore. The coolant passage can accept a coolant, which can be actively moved, such as by a pump. Alternatively, coolant in the coolant passage can be passively moved.

The brake caliper also has at least one piston slidably mounted in the bore. The piston can be made from a thermally conductive material, such as copper. The piston can include a cylindrical peripheral wall extending from a first end to a second end thereof. The wall is thicker at the first end than at the second end. The thicker end is that which contacts a brake pad.

In one embodiment, the coolant passage includes first and second branches and a third branch fluidically coupling the first and second branches. The housing includes a first section and a second section connected to one another by a bridge portion spanning a slot that is configured to receive a brake disc. The first branch is formed through the first section of the housing, and the second branch is formed through the second section of the housing. The third branch fluidically couples the first and second sections.

In another embodiment, the housing includes first, second, third, and fourth bores, and the first branch of the coolant passage extends radially outwardly from the first and second bores, and the second branch of the coolant passage extends radially outwardly from the third and fourth bores. The first and second branches extend perpendicularly to an axis the bore.

The brake caliper can also include a coolant inlet and a coolant outlet in the housing. The coolant inlet is fluidically coupled to the first branch of the coolant passage, and the coolant outlet is fluidically coupled to the second branch of the coolant passage. Where four bores are included, the coolant inlet is fluidically coupled to the first branch at the first bore of the housing and the coolant outlet is fluidically coupled to the second branch at the fourth bore of the housing.

In an embodiment, the housing includes (1) first and second bores situated on a first section of the housing and (2) third and fourth bores situated on a second section of the housing. A first coolant crossover passage connects the first and second bores, and a second coolant crossover passage connects the third and fourth bores.

Additional cooling can be provided by coolant in a gap between the piston and the bore. The gap extends axially between first and second seals.

The brake caliper can also include a brake pad mounted on the piston and including a friction pad made from a thermally conductive material, such as copper. The friction pad is mounted on a backing plate that includes a plating comprised of a thermally conductive material such as copper.

A method of cooling a disc brake assembly is also provided.

The coolant passage in the caliper takes heat out of the disc brake assembly before the heat gets to the brake fluid. Heat is dissipated by thermal exchange into the caliper, coolant, and/or the atmosphere. The coolant can be water, a conventional ethylene glycol (antifreeze) solution, an oil, a paste, a thermally conductive fluid, a phase change material, or any other thermally conductive material. Heat is moved from the disc to the brake pad to the piston and then to the coolant, which is used as a heat sink.

The invention results in brake fluid running cooler per unit time than in previous brake assemblies because heat is removed from brake assembly before it reaches the brake fluid during a brake stop or braking operation.

### BRIEF DESCRIPTION OF THE DRAWINGS

Preferred exemplary embodiments of the invention are illustrated in the accompanying drawings, in which like reference numerals represent like parts throughout and in which:

FIG. 1 is an isometric view of a disc brake assembly that is constructed in accordance with a first embodiment of the invention.

FIG. 2 is an exploded view of the disc brake assembly of FIG. 1.

FIG. 3 is a cross-sectional view through line 3-3 of FIG. 1.

FIG. 4A is a cross-sectional view through line 4-4 of FIG. 1.

FIG. 4B is a close up of the coolant bleeder of FIG. 4A with the bleeder in a closed position.

FIG. 4C is a close up of the coolant bleeder of FIG. 4A with the bleeder in an open position.

FIG. 5 a cross-sectional view through line 5-5 of FIG. 1 and showing a disc brake assembly that is constructed in accordance with a second embodiment of the invention.

FIG. 6 is a graph showing torque, pressure, and temperature data plotted against stop number from a braking test done on a disc brake assembly made in accordance with the first embodiment of the invention.

FIG. 7 is a graph showing torque, pressure, and temperature data plotted against stop number from a braking test done on a disc brake assembly made in accordance with the second embodiment of the invention.

Before explaining embodiments of the invention in detail, it is to be understood that the invention is not limited in its application to the details of construction and the arrangement of the components set forth in the following description or illustrated in the drawings. The invention is capable of other embodiments or being practiced or carried out in various ways. Also, it is to be understood that the phraseology and terminology employed herein is for the purpose of description and should not be regarded as limiting.

### DETAILED DESCRIPTION

1. Construction and Use of a First Preferred Embodiment of a Cooled Caliper

The calipers described herein can be used on disc brake assemblies that are mounted on wheels, such as on motorcycles, bicycles, snowmobiles, ATVs, automobiles, buses, and trucks, golf carts, go-karts, and the like. The invention is particularly well suited for use in a motorcycle braking system, which are particularly prone to brake fluid overheating because their brakes are operated at high speeds, high torques, and high duty cycles. High-performance motorcycle are also very weight sensitive, requiring the lightest-possible components. They are also space sensitive, requiring that the brake caliper and other system components be as small as reasonably possible. The brake caliper and the disc brake described herein meet all of these needs.

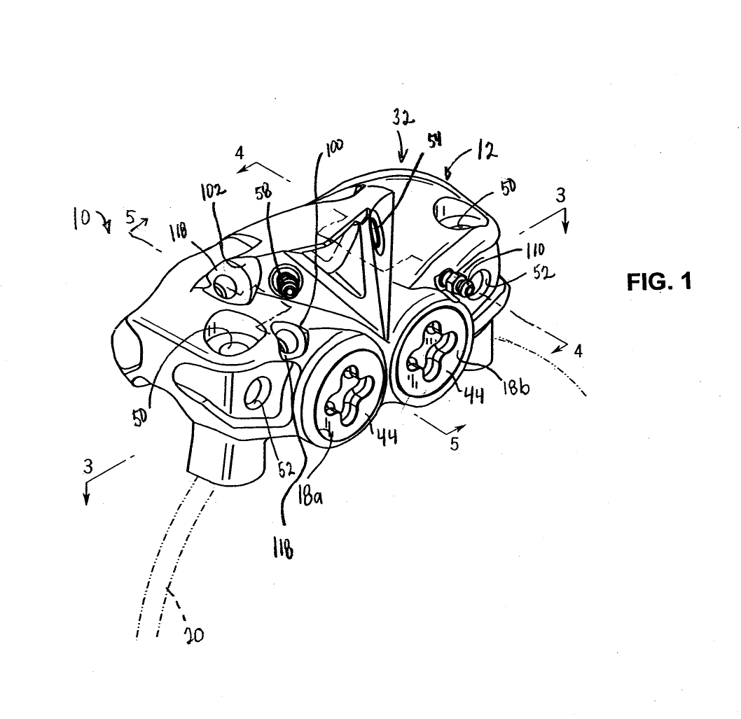

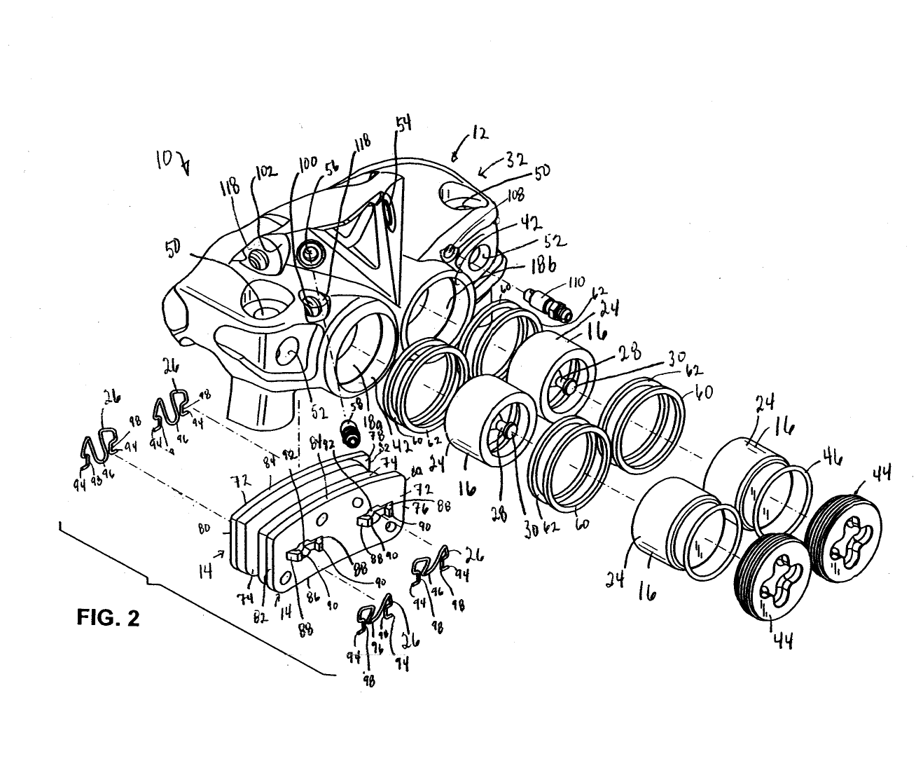

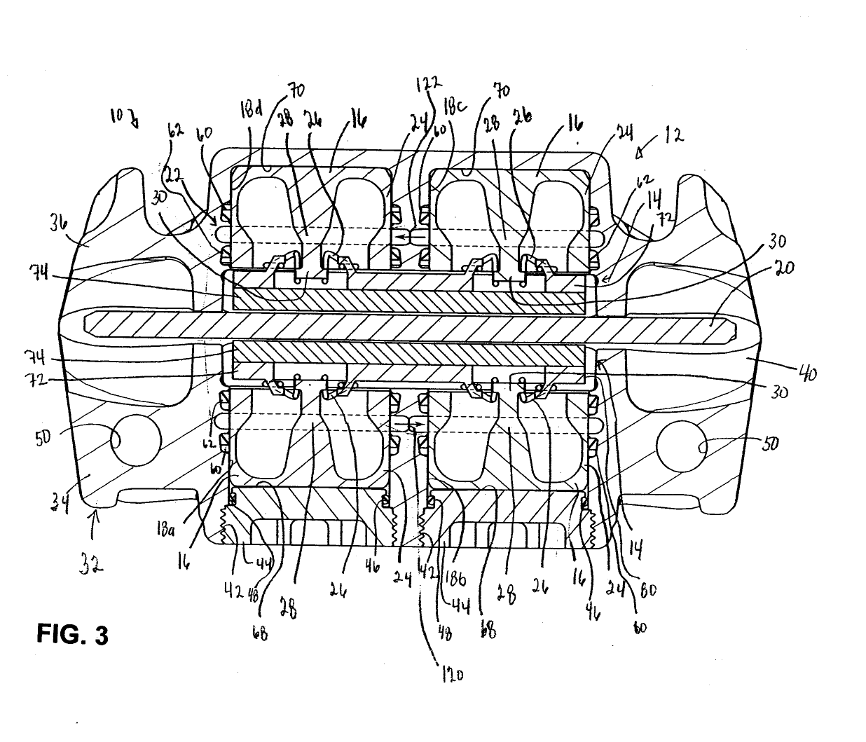

Referring now to FIGS. 1-3, a disc brake assembly 10 made in accordance with a first embodiment is shown. The disc brake assembly 10 includes a caliper 12, brake pads 14, each of which has two pistons 16 activating it. The calipers 12 described herein can be used on a dual piston caliper, a single piston caliper, on a caliper having a brake pad 14 actuated by two pistons 16, and on a caliper having a backing plate actuated by more than two pistons. The disc brake assemblies 10 will be described herein with respect to a two piston per brake pad application for convenience sake only. The invention is not limited to this application.

Each piston 16 has a rear axial end slidably mounted in a bore 18 in the caliper 12 and a front axial end that faces a disc 20. One or more caliper 12 can be used per wheel assembly. However, only one caliper 12 will be described for simplicity sake. Calipers of a typical motorcycle braking system are identical or mirror images of each other. Each brake pad 14 is disposed between the pistons 16 and the disc 20. The caliper 12 is cooled by a coolant in a coolant passage 22 in the caliper 12.

In one embodiment, the piston 16 is made from a highly thermally conductive material, such as aluminum or copper or the like. In another embodiment, the piston 16 is made from steel. Each piston 16 includes a cylindrical peripheral wall 24 extending from the front end to the rear end. From the front to the back, the wall 24 is tapered down to a thinner wall cross section such that it is thicker at the front end and is tapered down to a thinner wall cross section. The thicker part has higher heat capacity than the thinner part such that the thicker part transfers heat from the pad to the piston. Conversely, the thinner part has lower heat capacity, that is, more surface area per cross-sectional area, such that heat is not stored in the thinner part. Instead, heat is transferred to the coolant passage 22 in the caliper 12, as is detailed below.

In one embodiment, spring clips 26 connect the pistons 16 to one of the brake pads 14, as is described below. However, the piston 16 can be attached to the brake pads 14 with other attachment devices or in other ways. Where a spring clip 26 is used, in one embodiment the piston 16 includes a piston post 28 that projects from the rear axial end towards the disc 20. A cap 30 is provided on the end of the post 28. However, a spring clip 26 can connect the pistons 16 to one of the brake pads 14 in other ways, as is known in the art.

The caliper 12 includes a housing 32 having first and second sections 34, 36 connected to one another by a bridge portion 38 spanning a slot 40 that has a longitudinal centerline containing the disc 20. The first section 34 includes first and second piston bores 18a, 18b. The second section 36 includes third and fourth piston bores 18c, 19d. The piston bores 18a, 18b located on the first section 34 extend through the housing 32 such that each bore 18a, 18b defines an opening 42 in the housing 32 through which a pair of axially opposed pistons 16 is installed. Although the disc brake assemblies 10 is described herein as a caliper 12 in which axially opposed pistons 16 are installed from a single side, the caliper 12 can also be one in which the axially opposed pistons 16 are installed from two sides.

A plug 44 is threadably received in each opening 42. A hydraulic seal 46 is disposed in a groove 48 on the outer surface of each plug 44. The illustrated housing 32 is a fixed mount, four piston housing supporting two pairs of axially-movable pistons 16, which are mounted in each of the first and second sections 34, 36. Although the caliper 12 is described herein as a fixed caliper, the invention is also applicable to floating calipers.

The housing 32 is a metal housing, preferably made from aluminum or cast iron. Cast aluminum is lightweight, can be cast with complex internal and external features, and has high thermal conductivity. The high thermal conductivity promotes efficient conductive heat transfer from operative components of the caliper (namely, the brake pads and pistons) to coolant in the coolant passage as detailed below. Preferably, the entire housing 32, including both sections 34, 36 and the bridge portion 38, is a one-piece, cast body. A one-piece body is easier and less expensive to manufacture than a multiple-piece body. For example, a one-piece caliper eliminates many of the machining requirements that are necessary when manufacturing multiple-piece calipers. A one-piece aluminum housing is also very lightweight. The weight reduction results in an increased power-to-weight ratio—an important benefit in high-performance motorcycles and other vehicles. The housing could, alternatively, be a multiple-piece cast aluminum or iron body, the parts of which are bolted or otherwise connected together.

Where the caliper 12 is used on a motorcycle, the caliper 12 includes mount holes 50 disposed perpendicular to the axis of the piston 16 for mounting the caliper 12 on a motorcycle fork (not shown). Weight reduction holes 52 are disposed perpendicular to the mount holes 50. However, mounting holes 50 can also be parallel to the pistons 16 for motorcycles. A banjo hole 54 connects a brake line (not shown) to the caliper 12 for receiving and returning hydraulic fluid from a master cylinder (not shown). A brake bleeder hole 56, which receives a brake bleeder 58, permits removal of air from the brake line and bores 18. Between the banjo hole 54 and the brake bleeder hole 56, brake fluid pathways (not shown) are interconnected by cross drilled passageways (not shown) in the caliper 12 to deliver brake fluid to a brake fluid hydraulic port (not shown) each piston bore 18.

An outer peripheral surface of each piston 16 is sealed in the bore 18 via first and second square seals 60, 62 captured in grooves 64, 66 in the wall of each bore 18. The first seal 60 contacts the piston 16 near its rear end and dually functions as a hydraulic seal and a coolant seal. The second seal 62 contacts the piston 16 near its front end and dually functions as a coolant seal and a wiper. On the first section 34, a chamber 68 is formed between the rear end of each piston 16 and the plug 44. On the second section 36, a chamber 70 is formed between the rear end of each piston 16 and an axial end of each bore 18. The chambers 68, 70 can be pressurized with hydraulic fluid that is introduced into the brake fluid hydraulic port in each chamber 70 via the cross drilled passages to drive the pistons 16 towards the disc 20 to apply the braking force.

Each brake pad 14 includes a backing plate 72 and a friction pad 74 made from a suitable friction material that conducts heat, such as copper and other heat conductive metals. Carbides, silicons, and other materials can also be included in the friction pad 74. An exemplary thermally conductive friction material is a centered material. In one embodiment, the backing plate 72 is made from steel with a copper plate thereon. The backing plate 72 has a relatively flat rear surface 76, a relatively flat front surface 78, and left, right, upper, and lower side edges 80, 82, 84, and 86, respectively. The friction pad 74 is affixed to the front surface 78 of the backing plate 72 with heat and pressure in a sintering process. For example, a friction pad 74 made from a centered material can be affixed to the backing plate 72 by placing the friction pad 74 on the backing plate 72 and putting them in a sintering furnace.

Where a spring clip 26 is used, the rear surface 76 of the backing plate 72 includes two sets of opposed fingers 88 that project outwardly from the rear surface 76 of the backing plate 72. Each finger 88 includes a free end 90 that accepts a side of the spring clip 26 as is described below. A hole 92 is located between each set of opposed fingers 88.

Each piston 16 is securely clamped to the brake pad 14 by a spring clip 26, which is configured to permit the brake pad 14 to be installed in the assembly 10 and removed therefrom without using any special tools and without disassembling the brake system in any way. Towards these ends, the spring clip 26 takes the form of a wire form 26, which includes a pair of free ends 94 and a central U-shaped loop 96 that is disposed intermediate the free ends 94 and that is bent toward the backing plate 72. Each free end 94 forms a leg of a distal U-shaped loop 98, the bottom of which projects radially inwardly. The distal U-shaped loops 98 are configured to extend substantially in parallel with the rear surface 76 of the backing plate 72. Each of the distal U-shaped loops 98 is fitted between one of the pairs of fingers 88 on the backing plate 72 to hold the wire form 26 in place on the backing plate 72.

The maximum undeflected distance between the distal U-shaped loop 98 on one side of the spring clip 26 and the distal U-shaped loop 98 on the other side of the spring clip 26 is greater than the distance between the free ends 90 of the pair of fingers 88 on the backing plate 72 so that the wire form 26 must deflect radially when the wire form 26 is inserted behind the fingers 88. The brake pad 14 is installed on the backing plate 72 simply by compressing the spring clip 26 by pushing the distal U-shaped loops together 98. The spring clip 26 is inserted between the pair of fingers 88 on the backing plate 72. Pressure on the distal U-shaped loops 98 is released such that the spring clip 26 springs into the fingers 88, and spring clip 26 is held therein.

The brake pad 14 is connected to the piston 16 by sliding the brake pad 14 upward so that the central U-shaped loop 96 engages the post 28 and is retained thereon by the cap 30 of the post. When the central U-shaped loop 96 is fitted under the cap 30, the loop 96 is axially deflected with respect to the free ends 94 of the spring clip 26. The combination of radial and axial deflection minimizes or even eliminates movement of the brake pad 14 relative to the piston 16 both axially and radially, thereby preventing drag and rattle as well as unintended pad removal. The holes 92 in the backing plate 72 are aligned with the posts 28 on the pistons 16. The brake pad 14 is positioned on the pistons 16 by sliding the brake pad 14 into the slot 40 with the central U-shaped loops 96 aligned with the caps 30. The springs 26 are deflected, and the piston posts 28 are clear of the edge of the backing plate holes 92. The brake pad 14 can be slid out of the bottom of the caliper housing 32. This is the only avenue of escape for the brake pad 14 as the other three sides are closed.

The caliper 12 also includes a coolant inlet 100 and a coolant outlet 102 disposed above the first and fourth piston bores, 18a and 18d, respectively. The coolant inlet 100 terminates in a coolant inlet bore 104 in the first piston bore 18a, and the coolant outlet 102 terminates in a coolant outlet bore 106 in the fourth piston bore 18d. The caliper 12 further includes a coolant bleeder hole 108 that receives a coolant bleeder 110 and that is disposed above the second piston bore 18b and is fluidically coupled to the coolant inlet 100 and coolant outlet 102.

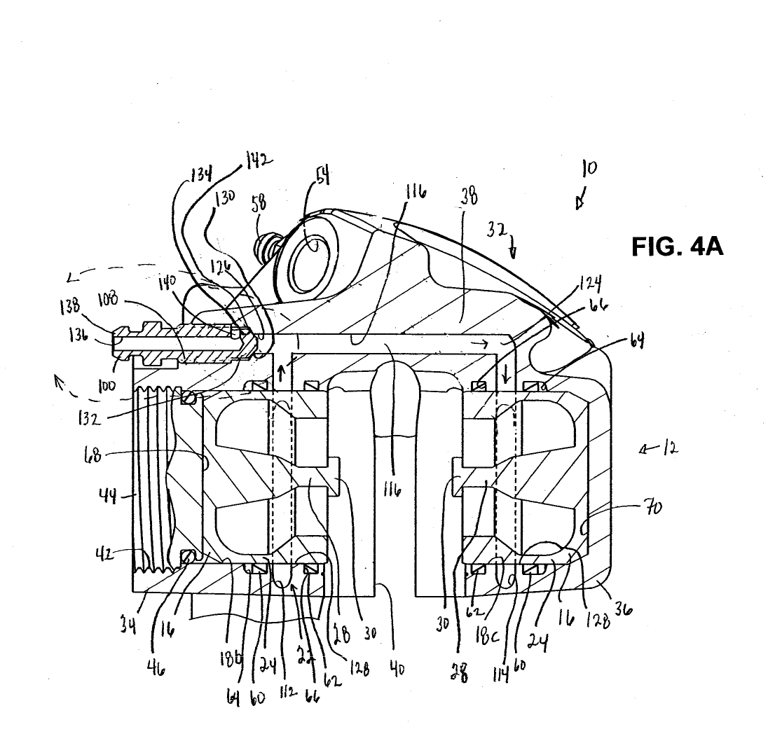

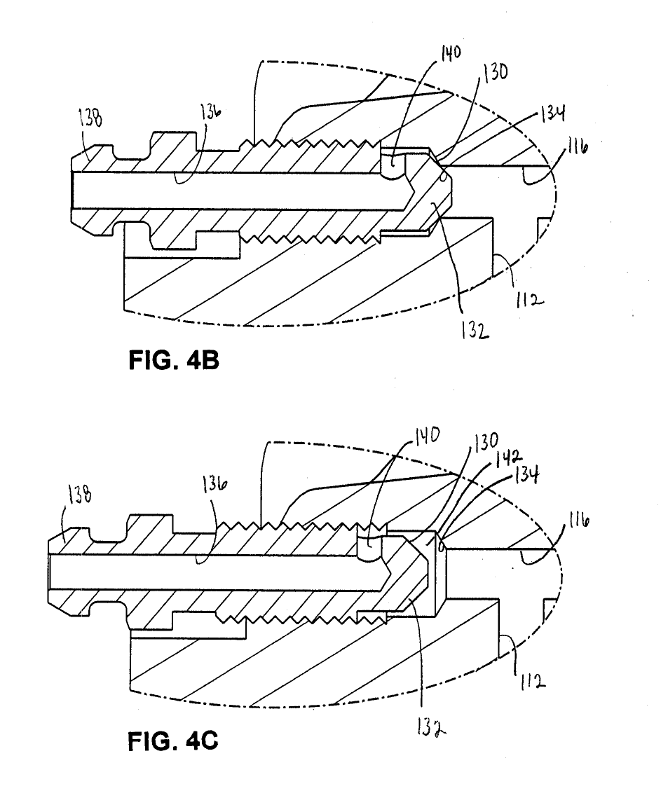

As best seen in FIG. 4A, the coolant passage 22 of the caliper 12 includes first and second branches 112, 114, respectively, and a third branch 116 connecting first and second branches 112, 114, respectively. The first and second branches 112, 114, respectively, are formed through the first section 34 and second section 36, respectively, of the housing 32. The first and second branches 112, 114, respectively, extend perpendicularly to the axis of the disc 20 and extend perpendicularly to the axial path of the pistons 16. The first branch 112 extends radially outwardly from the first and second bores 18a, 18b. The second branch 114 extends radially outwardly from the third and fourth bores 18c, 18d. The coolant inlet 100 is fluidically coupled to the first branch 112, at the first bore 18a and the coolant outlet 102 is fluidically coupled to the second branch 114 at the fourth bore 18d. Each of the coolant inlet 100 and coolant outlet 102 are tapped and receive a threaded plug 118. A first coolant crossover passage 120 connects the first and second bores 18a, 18b on the first section 34 of the caliper 12, and a second coolant crossover passage 122 connects the third and fourth bores 18c, 18d on the caliper's second section 36. The third branch 116 extends perpendicularly to the first and second branches 112, 114 and fluidically connects to them. One end 124 of the third branch 116 ends at the second branch 114, and the other end 126 extends beyond the first branch 112. Coolant enters the coolant passage 22 at the coolant inlet 100 and passes into the portion of the first branch 112 around the first bore 18a and to the portion of the first branch 112 around the second bore 18b via the first coolant crossover passage 122. Coolant moves to the second branch 114 around the third bore 18c via the third branch 116. Coolant moves to the portion of the second branch 114 around the fourth bore 18d via the second coolant crossover passage 124 and then to the coolant outlet 102. Coolant also moves along a gap 128 between each piston 16 and its respective bore 18. Each gap 128 extends axially between first and second seals 60, 62 to provide additional heat transfer along a portion of the length of the piston 16 where the piston wall 24 is thinner. Thus, heat is transferred from the thinner piston wall 24 to coolant in the coolant passage 22.

This first embodiment is a non-circulating one, that is, coolant remains in the caliper 12 and does not pass to other parts of the vehicle. The coolant inlet and coolant outlet can include a cap (not shown) that substantially prevents coolant from moving outside the caliper. In this first embodiment, the coolant preferably is a heat conductive grease, preferably one with low expansion. However, other coolants, such as those listed above, can be used in this embodiment.

Referring now to FIGS. 4B-4C, the coolant bleeder 110 is inserted into the other end 126 of the third branch 114 of the passage 22 above the second bore 18b. The coolant bleeder 110 is made from a metal material such as steel. The coolant bleeder 110 includes a flat 130 on a first end 132 thereof that mates with a corresponding flat 134 on the third branch 114 to form a seal. The coolant bleeder 110 includes an axial opening 136 that extends through a second end 138 thereof and a hole 140 connecting the axial opening 136 to the outer edge of the coolant bleeder 110. When torque is applied to the coolant bleeder 110 and it is pulled back away from the flat 134 on the third passageway 114, air can move from the third passageway 114 through a gap 142 between the two flats 130, 134, through the hole 140, and into the axial opening 136 in the coolant bleeder 110 and to the atmosphere. This air removal property can be used when filling the coolant passage 22 with coolant. For this, coolant is added until only coolant (and at least substantially no air) flows out of the axial opening 136.

In use, upon master cylinder actuation, a brake fluid is admitted into the bores 18 of the caliper 12 to drive the respective pistons 16 into positions in which the brake pads 14 frictionally engage opposite sides of the rotating disc 20. Heat is generated as a result of this frictional contact. Heat is removed from the disc 20 to the brake pads 14 made of highly thermally conductive material and to pistons 16 having a thicker wall 24 at the front end. Heat is moved from the thicker wall 24 to the thinner wall 24 of the piston 16 and then into the coolant in the coolant passage 22 and the gap 142 surrounding the piston 16. Heat is transferred by conductive heat transfer.

Because the cooled brake caliper 12 is efficiently cooled, a thinner disc 20 can be used with the cooled caliper 12. For example, a disc that is from about 0.15 inches to about 0.22 inches can be used. This provides better vehicle cornering response due to reduced inertia, which reduces gyroscopic effect on the wheel. The cooled caliper 12 can therefore be worked harder than a non-cooled or a previously-designed cooled caliper, such as this baffled caliper described in the Background section. Therefore, the size of the caliper can be downsized for a particular application. This results in further weight reduction and further cost reduction. The cooled caliper 12 is also more efficient because in contrast to some previous cooled calipers, heat is removed before it reaches the brake fluid.

In this embodiment, where the coolant is not actively moved by a pump, the thermally conductive fluid brings the heat into the coolant in the coolant passage 22 and into the brake caliper. Heat in the caliper dissipates into the environment and/or atmosphere.

2. Construction and Use of a Second Preferred Embodiment of a Cooled Caliper

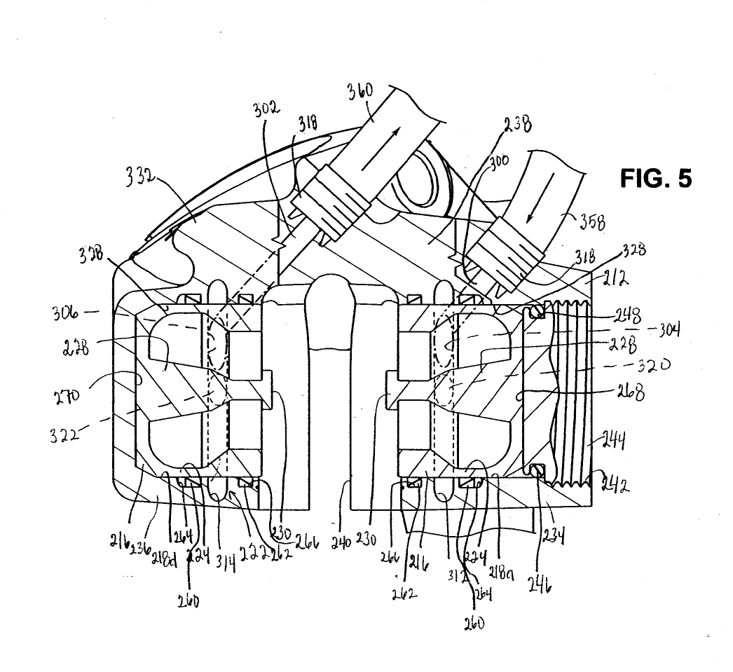

A second embodiment of the disc brake assembly is shown in FIG. 5. The disc brake assembly of the second embodiment is substantially identical to the first embodiment of the disc brake assembly 10 except that the coolant is re-circulated by connecting the coolant passage to a vehicles' existing coolant system or existing oil system. Elements of the disc brake assembly 10 are, accordingly, designated by the reference numeral incremented by 200. In the illustrated embodiment, the disc brake assembly 210 includes brake pads 214, each of which has two pistons 216 activating it. Each piston 216 has a rear axial end slidably mounted in a bore 218 in a caliper 212 and a front axial end that faces a disc (not shown). Each brake pad 214 is disposed between the pistons 216 and the disc. The caliper 212 is cooled by a coolant in a coolant passage 222 in the caliper 212. The coolant passage 222 includes a coolant inlet 300 and a coolant outlet 302 that are disposed above first and second piston bores 218a and 218b, respectively. A coolant bleeder hole 308 is disposed above the second piston bore 218b and is fluidically coupled to the coolant inlet 300 and coolant outlet 302.

The coolant passage 222 includes first and second branches 312, 314, respectively, a third branch 316 connecting first and second branches 312, 314, respectively, and coolant bleeder 310 as in the first embodiment. Coolant flows through the coolant passage 222 and a gap 342 between each piston 216 and its respective bore 218 the same way as in the first embodiment except that coolant is actively moved. In one embodiment, coolant is moved by pumping the coolant with a pump (not shown) of the existing coolant system (not shown) driven by the vehicle's engine (not shown). A main coolant supply line 348 couples an outlet (not shown) of the pump to an inlet of a conventional heat exchanger (not shown), and a main coolant return line 354 couples an outlet of the heat exchanger to an inlet of the pump. The pump continuously circulates a coolant, preferably a conventional ethylene glycol (antifreeze) solution, through the heat exchanger via the main supply and return lines (not shown).

Coolant supply and return conduits 358, 360 tap into the respective main supply and return lines of the engine coolant system as best seen in FIG. 5. The coolant supply and return conduits 358, 360 are connected to the coolant inlet and outlet 300, 302, respectively, with a standard flare fitting to the plugs 318 in the coolant inlet and outlet 300, 302.

Heat is transferred from the disc to the brake pad 214 to the backing plate 272 to the friction pad 274 to the piston 216. The piston 216 is cooled by the coolant in the coolant passage 222, thereby removing heat from the caliper 212 before it reaches the brake fluid. As a result, brake fluid can be kept within a normal range. The brake pad is cooled by heat being removed from the brake pad 214 by thermal conduction between the pad 214 and the cooled piston 216. Keeping the pads 214 at a lower temperature prolongs its life.

In another embodiment, the coolant is oil and it is moved by pumping it with a pump (not shown) of an existing oil system (not shown) by fluidically coupling the coolant passage 222 and the oil system.

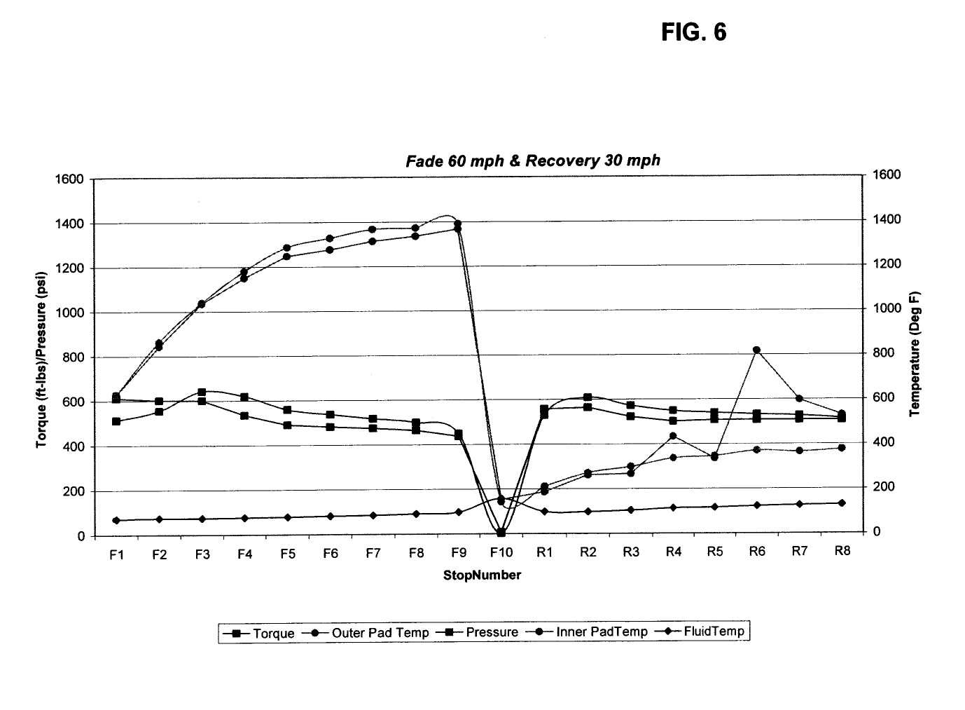

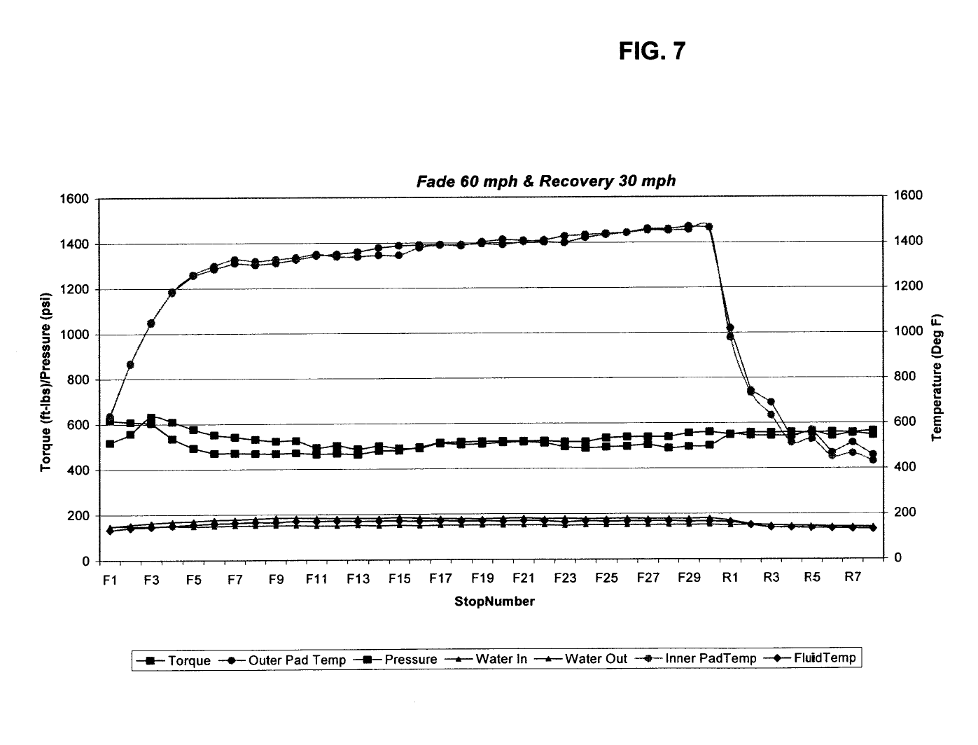

Referring now to FIGS. 6 and 7, with the caliper described herein using a steel piston, tests were conducted running a brake at 60 mph with and without coolant (water) in the coolant passage. The brake was applied multiple times, with the brake number shown on the X axis. FIG. 6 shows torque and temperature data from the caliper not containing coolant. With successive braking events, the temperature of the inner and outer pad and the brake fluid rises until at the tenth stop (F10), the brake fluid boils and both torque and pressure are lost. During recovery and braking at 30 mph, the temperature of the inner and outer brake pads and brake fluid rise again.

Referring to FIG. 7, the same test was run except this time with a circulating coolant (water). The temperature of water entering the caliper and exiting the caliper was measured and plotted. With coolant circulating, brake torque and pressure were not lost, and thirty braking events (F30) could be accomplished. This is three times the number of braking events that could be accomplished with the caliper lacking coolant.

Another test was run using the caliper described herein with a copper piston and circulating coolant brake fluid temperature raised and then the temperature reached a steady state regardless of the number of braking events.

It is understood that the various preferred embodiments are shown and described above to illustrate different possible features of the invention and the varying ways in which these features may be combined. Apart from combining the different features of the above embodiments in varying ways, other modifications are also considered to be within the scope of the invention. The invention is not intended to be limited to the preferred embodiments described above, but rather is intended to be limited only by the claims set out below. Thus, the invention encompasses all alternate embodiments that fall literally or equivalently within the scope of these claims.

What is claimed is:

1. A brake caliper comprising:
(A) a housing having (1) at least one bore formed therein, (2) a coolant passage formed through the housing and extending radially outwardly from and being fluidically coupled to the bore; and
(B) at least one piston slidably mounted in the bore.

2. The brake caliper of claim 1, wherein the coolant passage comprises:
(A) first and second branches; and
(B) a third branch fluidically coupling the first and second branches.

3. The brake caliper of claim 2, wherein the housing comprises a first section and a second section connected to one another by a bridge portion spanning a slot that is configured to receive a brake disc, and
wherein the first branch is formed through the first section of the housing and the second branch is formed through the second section of the housing.

4. The brake caliper of claim 3, wherein the housing comprises first, second, third, and fourth bores, and
wherein the first branch extends radially outwardly from the first and second bores and the second branch extends radially outwardly from the third and fourth bores.

5. The brake caliper of claim 2, wherein the first and second branches extend perpendicularly to an axis the bore.

6. The brake caliper of claim 2, further comprising a coolant inlet in the housing and a coolant outlet in the housing, wherein the coolant inlet is fluidically coupled to the first branch and the coolant outlet is fluidically coupled to the second branch.

7. The brake caliper of claim 6, wherein the housing comprises first, second, third, and fourth bores, and
wherein the coolant inlet is fluidically coupled to the first branch at the first bore of the housing and the coolant outlet is fluidically coupled to the second branch at the fourth bore of the housing.

8. The brake caliper of claim 1, further comprising a coolant inlet in the housing and a coolant outlet in the housing, and
wherein each of the coolant inlet and coolant outlet include a cap that substantially prevents coolant from moving outside the caliper.

9. The brake caliper of claim 1, further comprising a pump that moves coolant in the coolant passage.

10. The brake caliper of claim 1, wherein the housing comprises (1) first and second bores situated on a first section of the housing and (2) third and fourth bores situated on a second section of the housing, and further comprising:
(A) a first coolant crossover passage connecting the first and second bores; and
(B) a second coolant crossover passage connecting the third and fourth bores.

11. The brake caliper of claim 1, further comprising a gap between the piston and the bore, the gap extending axially between first and second seals.

12. The brake caliper of claim 1, wherein the piston is made from a thermally conductive material.

13. The brake caliper of claim 12, wherein the piston is made from copper.

14. The brake caliper of claim 1, further comprising a brake pad mounted on the piston, the brake pad comprising a friction pad made from a thermally conductive material.

15. The brake caliper of claim 14, wherein the friction pad is made from a material including copper.

16. The brake caliper of claim 1, further comprising a brake pad mounted on the piston, the brake pad comprising a backing plate that includes a plating comprised of a thermally conductive material.

17. The brake caliper of claim 16, wherein the thermally conductive material comprises copper.

18. The brake caliper of claim 1, wherein the piston comprises a cylindrical peripheral wall extending from the first end to a second end thereof, the wall being thicker at the first end than at the second end.

19. The brake caliper of claim 1, wherein housing is a one-piece housing.

20. The brake caliper of claim 1, wherein housing is a multiple-piece housing.

21. A method comprising:
(A) admitting a brake fluid into a bore of a caliper to drive a piston into positions in which a brake pads made of thermally conductive material frictionally engages opposite sides of a rotating disc, wherein heat is generated as a result of the frictional contact;
(B) moving the heat from the disc and brake pads to the piston; and
(C) moving the heat from the piston to a coolant in a coolant passage fluidically coupled to the bore, wherein heat is removed before it reaches the brake fluid.

22. The method of claim 21, further comprising actively moving the coolant in the coolant passage.
